(19) United States
(12) Patent Application Publication
(10) Pub. No.: US 2004/0015737 A1
(43) Pub. Date: Jan. 22, 2004

(54) Method and apparatus for automated signal integrity checking based on storage device functionality

(76) Inventors: Robert J. Martin, Timnath, CO (US); William Richard Lawrence, Windsor, CO (US); Francisco A. Ostojic, Fort Collins, CO (US); Mark E. Hammer, Loveland, CO (US); Michael Rogers Lambert, Fort Collins, CO (US); Edward V. Weber, Ft. Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/199,138

(22) Filed: Jul. 19, 2002

(51) Int. Cl. H04B 1/74

(52) U.S. Cl. 714/26

(57) ABSTRACT

A method of characterizing and simulating electronic systems for signal integrity is presented. Each device in the electronic system is associated with at least one vulnerability table and at least one vulnerability window. The vulnerability table is a three dimensional table that characterizes the operation of the device and includes line length on one axis, coupling efficiency on another axis and drivers size of a gate, on the third axis. In addition a number of vulnerability windows are presented. The vulnerability window is a time period when a storage device may store the wrong data because of signal integrity issues in the electronic system. A vulnerability window is developed for each input to a storage device in the system. In addition a vulnerability window is developed based on a number of failure mechanisms used to characterize the system. Lastly, a mapped vulnerability window is presented for devices such as logical gates, which provide input to the storage device. The mapped vulnerability windows are a function of the vulnerability windows for the storage device and the time delay for a signal communicated from a gate under study to the storage device.

### CROSS-REFERENCE TO RELATED APPLICATION

This application is related to U.S. application Ser. No. ______ filed ______, which is hereby incorporated by reference in its entirety.

### BACKGROUND OF THE INVENTION

1. Field of the Invention

This invention relates to simulation. Specifically, the present invention relates to the simulation of electronic systems.

2. Description of the Related Art

Conventional electronic systems include hundreds and often millions of devices (e.g. logic gates, storage devices, etc). These electronic systems are often deployed in integrated circuits, microprocessors or printed circuits boards. With the increased demand for complex electronic systems, there is also a demand to reduce the cycle time for deploying the electronic systems. As a result, there has been an increased interest in the area of electronic system simulation.

Electronic system simulation is a computer software approach to modeling and then simulating an electronic system. Devices are modeled and then combined into the configuration of the electronic system to determine how the devices will interact with each other during operation. Problems in design or implementation may then be determined and redesigns or reengineering may be performed.

Simulation results in cost savings in deploying an electronic system, reduces the cycle time and provides additional flexibility and confidence to designers and manufacturers deploying electronic systems. Ultimately, manufacturers realize value because they are able to deploy a better quality product with fewer flaws.

In a conventional electronic system, performance parameters are used to define a specific device. The parameters define the operation of the device. The parameters may be produced based on empirical models of the device or from historical knowledge of the operation of the device under different conditions. The parameters are often stored in files or libraries and then used by conventional simulation programs to simulate the operation of the device under different conditions.

Combining these devices facilitates the simulation of the electronic system. Simulating a combination of the devices enables a designer or manufacturer to understand how the devices will interact with the various other devices in the electronic system. Ultimately, a simulation of the electronic system provides insight into the operation and performance of the electronic system.

One area of simulation that has received some amount of attention is the area of signal integrity. With so many devices (e.g. transistors, logic gates, storage units) located so close together, signals often couple to other signals (e.g. cross-couple). Therefore, in addition to the analysis of electronic systems and the electronic devices in these systems, analysis is now being performed on the signals (e.g. traces) running between devices or the signal integrity of the system.

One specific type of signal integrity problem in electronic systems is known as cross-coupling. There are several types of cross-coupling, such as capacitive coupling, inductive coupling and conductive coupling. In a system where numerous metal wires or traces are located within proximity of each other, there is an electrical field between the two metal wires when there is a potential difference between the two wires. For example, if one wire is at zero volts and the other wire is at 5 volts, an electrical field results between the two metal wires. In capacitive coupling, when there is a change in the potential on one of the metal wires, through the electrical field, a change may occur on the other metal wire. Inductive coupling is similar except that instead of an electrical field, an electro-magnetic field exist between the two wires. An electromagnetic field may cross multiple wires therefore, many more wires may be affected by inductive coupling. Lastly, conductive coupling occurs when there is physical contact between the wires.

With so many devices in electronic systems and traces between these devices, the electricity running on one trace (e.g. wire) may couple onto a second trace. The trace that couples onto the second trace is known as an aggressor. The trace coupled onto by the aggressor is known as the victim. The coupling may be a capacitive coupling, which is simulated using a capacitor between the two traces.

Design techniques have been developed to address the problem of cross-coupling. In one technique, the traces that are coupling to each other are separated so that their capacitive effects do not interfere with each other. In a second technique, a ground wire is placed between a victim trace and an aggressor trace and as a result, the electrical fields associated with the wires will terminate at ground. Therefore any coupling between the two wires will go to ground.

Although these techniques have been developed to address the problem of cross-coupling, they are often costly and very time consuming. In addition, when using simulation techniques to address the problem of cross-coupling there are so many devices and traces to simulate, that it becomes a prohibitive task.

The task of simulating electronic systems becomes prohibitive for many reasons. As mentioned above the shear volume of devices and traces that are required for simulation is prohibitive. In addition, the accuracy of the simulation may be problematic. For example, since the electronic system may not be built at the time of the simulation, the simulation is an attempt to model the real-world or physical operation of the electronic system. The model should accurately recreate the operation of the electronic system so that designers can troubleshoot problem areas. However, many of these models do not accurately represent the operation of the electronic system. Many of the simulation models, mischaracterize the operation of the electronic system and as a result, defective product may be produced by a manufacturer.

There are many conventional approaches for simulating electronic systems. Most of these techniques revolve around modeling the performance of devices or modeling the speed that signals propagate through the electronic system. Both of these approaches attempt to provide a real world simulation of how an electronic system will operate when the electronic system is deployed in hardware. However, both of these approaches often alert designers to problems that are not there (e.g. false positives) and both approaches often fail to alert designers to problems that are in the system (e.g. true positives).

Thus there is a need in the art for techniques that simulate signal integrity. There is a need in the art for new approaches to simulation, which reduce the amount of false positives and identify all true positives. There is a need in the art for a quick and accurate method of simulating an electronic system. Lastly, there is a need in the art for simulation models that accurately characterize the operation of a real-world electronic system.

### SUMMARY OF THE INVENTION

A method and apparatus are presented for characterizing an electronic system. As a result, the signal integrity of the electronic system may be simulated. An electronic system with a number of components or devices is presented. A vulnerability table is created for each input of each device in the electronic system. The vulnerability table is a function of the line length of a signal wire, the coupling efficiency of signals coupling onto the signal wire and the drive strength of a device driving the signal wire.

In addition, a vulnerability window is developed for each signal input to a device in the electronic system. In one method of the present invention, a vulnerability window defines a period of time during which cross-coupling may occur on an input to a storage device and cause the storage device to produce or store incorrect data.

The vulnerability window is created based on a number of failure mechanisms that are used to characterize the operation of the electronic system. The first two failure mechanisms are associated with the data input to a storage device. The first two failure mechanisms are known as a data flow failure mechanism and an overshoot/undershoot failure mechanism. The third failure mechanism is associated with the clock input to the storage device. The fourth and fifth failure mechanisms are associated with the control input to the storage device. The fourth failure mechanism is associated with a synchronous control input to a storage device and the fifth failure mechanism is associated with an asynchronous control input to a storage device.

A mapped vulnerability window is created for gates along a signal path that provides input a storage device. The mapped vulnerability windows are a function of the vulnerability windows associated with the storage device. The mapped vulnerability windows are also a function of the various failure mechanisms; such as the data flow failure mechanism, the clock failure mechanism, the synchronous control failure mechanism and the asynchronous control failure mechanism.

A gate generating signals along a signal path (e.g. trace or wire) that ultimately reaches the storage device is characterized based on a vulnerability table for the gate and a mapped vulnerability window, which is based on vulnerability windows associated with storage devices. The electronic system is then simulated using the vulnerability tables, the vulnerability windows and the mapped vulnerability windows.

A method of characterizing an electronic system comprises the steps of defining a range of drive strengths; defining a range of line lengths; defining a range of coupling efficiency values; and generating a vulnerability table in response to the range of drive strengths, in response to the range of line lengths and in response to the range of coupling efficiency values.

A method of characterizing an electronic system comprises the steps of (a) defining a first drive strength; (b) identifying a first signal path including first line length; (c) identifying a second signal path including a second line length, wherein the second line length is equivalent to the first line length; (d) modeling coupling between the first signal path and the second signal path; (e) establishing a coupling efficiency; (f) generating a noise value in response to the drive strength, in response to the first line length and in response to the coupling efficiency; (g) generating a column in a two-dimensional vulnerability table by repeating steps (e) through (f); (h) generating a two-dimensional vulnerability table by repeating steps (b) through (g); and (i) generating a three-dimensional vulnerability table by repeating steps (b) through (h) and defining a second drive strength wherein the second drive strength is different from the first drive strength.

A method of characterizing an electronic system comprises the steps of defining a plurality of devices in the electronic system; and generating a plurality of vulnerability tables, with at least one of the vulnerability tables associated with at least one of the plurality of devices.

A method of characterizing an electronic system comprises the steps of defining a vulnerability window for an input to a storage device; determining a range of delay times for a signal communicated from a driving device to the input to the storage device; and generating a mapped vulnerability window in response to the vulnerability window and in response to the range of delay times.

A method of characterizing an electronic system, the method comprises the steps of identifying an input to a storage device; and generating a vulnerability window for the input to the storage device.

A method of determining signal integrity in an electronic system comprises the steps of simulating operation of the storage device including a node; and characterizing the signal integrity of the electronic system by measuring the node of the storage device to determine a state of the storage device.

A method of determining signal integrity in an electronic system comprises the steps of simulating operation of a gate driving a storage device, the storage device including a node; and characterizing the signal integrity of the electronic system by measuring the node of the storage device to determine a state of the storage device.

A method of characterizing an electronic system, the electronic system including at least one trace providing a signal to a storage device, the method comprises the steps of defining a time period during which noise on the trace will cause the storage device to store incorrect data; and defining device relationships in the electronic system in response to the time period.

A method of determining signal integrity in an electronic system comprises the steps of defining a storage device including an input; generating a vulnerability table associated with the input of the storage device; generating a vulnerability window associated with the input to the storage device; and defining invalid operation of the electronic system in response to the vulnerability table associated with the storage device and in response to the vulnerability window associated with the input to the storage device.

A method of determining signal integrity in an electronic system comprises the steps of defining a gate driving a storage device, the storage device including a vulnerability window associated therewith; generating a vulnerability table associated with the gate; generating a mapped vulnerability window associated with the gate, the mapped vulnerability window generated in response to the vulnerability window associated with the storage device; and defining invalid operation of the electronic system in response the vulnerability table associated with the gate and in response to the mapped vulnerability window associated with the gate.

### BRIEF DESCRIPTION OF THE DRAWINGS

FIG. 1 displays a vulnerability table.

FIG. 2 displays a diagram of a storage device.

FIG. 3 displays a circuit implementing the method of the present invention.

FIG. 4 displays a circuit modeling cross coupling.

FIG. 5 is a block diagram of a computer.

FIG. 6 is a flow diagram of a method of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Digital electronic systems include a number of components or devices. These devices include logical gates such as NAND gates and NOR gates. In addition, digital electronic systems include storage devices. These storage devices may be implemented with flip-flops, latch arrays, inverters, etc. The storage devices receive a plurality of inputs, such as data inputs, clock inputs and control inputs. In addition, a storage device can store or hold a specific value or state (e.g. logical 0 or logical 1).

Signals are communicated between various devices in the electronic system. The signals travel along traces or wires. In the method and apparatus of the present invention, traces and wires will be used interchangeably to denote a signal path. The signal path may go directly from one device to a second device or may go through several devices.

In digital electronic systems implemented in accordance with the teachings of the present invention, data signals travel on traces (e.g. wires) that connect digital devices such as logical gates and storage devices. The signals are characterized as being in a high state (e.g. logical 1) or in a low state (e.g. logical 0). In addition, the signals communicated on traces may transition from a logical 1 to a logical 0. The transition is characterized as a rising transition when the signal goes from a logical 0 to a logical 1. The transition is characterized as a falling transition when the signal goes from a logical 1 to a logical 0. A digital component or storage device may respond to a transition on the rising edge of the transition (e.g. where the transition begins) or on the falling edge of the transition (e.g. where the transition ends).

In a digital electronic system, the amount of voltage that equates to a logical 1 and the amount of voltage that equates to a logical 0 is predefined. Physically, a logical 1 may correspond to a predefined amount of voltage such as a positive five volts and a logical 0 may corresponds to less volts than the logical 1, such as zero volts. Thus a trace carrying a logical 1, physically corresponds to a wire or connection that is at a predefined voltage such as plus five volts. A trace carrying a logical 0, physically corresponds to a wire or connection that is at a predefined voltage such as zero volts. A transition, physically corresponds to a trace changing voltage from plus five volts to zero volts (e.g. falling transition) or a trace changing voltage from zero volts to plus five volts (e.g. rising transition). In addition, as a result of different factors in the electronic system such as the resistance of the wires, cross-coupling effects, etc, in some instances less than five volts may be read as a logical 1 by a device and more than zero volts may be read as a logical 0 by a device.

A transition is communicated through an electronic system arriving at different locations and at different devices, at different times. For example, at time T1 a transition may be located at one point within a trace and at time T2 a transition may be located at another location within a trace. Since transitions arrive at different points in the system at different times, storage components are used to “gate” and resynchronize the data being processed by an electronic system.

Digital electronic systems also include one or more clock signals. The clock signals are also characterized as high (e.g. logical 1) or low (e.g. logical 0). In addition, a clock signal may transition from a logical 1 to a logical 0. A rising transition would be characterized by a clock signal transitioning from a logical 0 to a logical 1. A falling transition would be characterized by a clock signal transitioning from a logical 1 to a logical 0. In addition, the devices in a digital system may respond to the rising edge of the clock signal or the falling edge of the clock signal. At each change or transition of a clock signal(s) the devices (e.g. gates, storage devices, etc) in the electronic system may change states. However, it should be appreciated that not every device changes state on every transition of a clock signal.

Storage devices in a digital electronic system may include one or more data inputs, a clock input and one or more control inputs. A data input to a storage device may carry a logical 1 value or a data input to a storage device may carry a logical 0 value. A storage device may store a state such as a logical 1 or a logical 0. When a storage device stores a value (e.g. 1 or 0) and is not transitioning, the storage device is said to be in steady state. A storage device is either in steady state or transitioning.

The transitions traveling on a data input to a storage device may also be characterized as rising or falling. A rising transition occurs where the input signal to the storage device moves from a low state to a high state and a falling transition occurs when the data input signal to a storage device moves from a high state to a low state. In addition, the storage device may respond to the rising or falling edge of the data input signal.

A storage device in a digital electronic system also receives a clock input. The clock input may be high, low or transitioning. A high signal corresponds to a logical 1. A low signal corresponds to a logical 0. In addition, the clock signal may have a rising transition in which the clock signal transitions from a low state to a high state or a falling transition in which the clock signal transitions from a high state to a low state. The storage device may respond to the rising edge of a clock transition or to the falling edge of a clock transition.

A storage device may also have one or more control inputs. The control inputs enable a number of functions such as updating the storage device, providing asynchronous or synchronous functionality or providing a complete set/reset of the storage device. The control input performs these functions by communicating a signal transition to the storage device. The control signal transition may be low (e.g. 0), high (e.g. 1) or transitioning. In addition, the control signal transition may be a rising transition in which a control signal transitions from a low to a high or a falling transition in which the control signal transitions from a high to a low. The storage device may respond to the rising edge of the control signal transition or to the falling edge of the control signal transition.

Storage devices implemented with latches, flip-flops, etc, take time to change states. The time required to change states (e.g. transition) is known as the set up and hold time, which consist of two time periods. The first time period is known as the set-up time and the second time period is known as the hold time. The time period, prior to the clock transition, during which data input to a storage device must be stable, is known as the setup time. The time period, after the clock transition, when a data input to a storage device must remain stable, is known as the hold time. Therefore the setup and hold time is defined as the time period between the clock transition minus the setup time and the clock transition plus the hold time.

In the present invention, a timing window is associated with each wire (or trace) in the electronic system. A timing window is a time period that is bounded by the earliest time a transition may occur on the wire and the latest time a transition may occur on the wire. Therefore the timing window gives the outer timing boundary, for signal transitions entering an electronic component. In a storage device, there is a timing window for transitions communicated on the data input, the clock input and the control input. Therefore, each of these three inputs may have timing windows.

In the method and apparatus of the present invention an error is defined as when a storage device (e.g. internal node or output port) produces an incorrect or invalid state (e.g. 0 or 1). The storage devices are modeled using a simulator. Different storage device types and performance parameter are stored in a library associated with the simulator. The expected performance parameters of a storage device are taken from the library. As a result, during simulation, the state of a device at any point can be calculated (e.g. an expected state). The expected state is compared against the actual state produced during the simulation to determine whether there is an incorrect or invalid state.

During the simulation, the storage devices are monitored. In accordance with the teachings of the present invention, either one of two monitoring techniques are used. In the first technique, an external node of a storage device under analysis is monitored to determine whether the external node is at the correct state. In the present invention, the external node of a storage device is monitored to determine if the storage device has stored invalid data.

In a second technique, an internal node of a storage device is monitored to determine if invalid data has been stored in the storage device. The storage devices may be implemented using a combination of digital logic devices such as AND gates, OR gates, etc. An internal node in the storage device, which may be a connection between two logic devices, is tested for the current state. As a result, it is possible to monitor the internal node for an invalid state by comparing the current state to the expected state.

Traces carrying signals to storage devices or output ports may be defined as aggressor traces or victim traces. In the method and apparatus of the present invention, victim traces are wires, which input into a storage device or have a signal path to a storage device and receive enough coupling (e.g. capacitive, inductive, conductive), to cause the storage device to store an invalid state. Aggressor traces are wires carrying signals which couple onto the victim wires. The aggressor traces and victim traces may carry electrical signals to a single component or may carry electrical signals to multiple components.

In the present invention, each trace can be both an aggressor trace or a victim trace. In addition, traces couple during a transition of state, therefore, the aggressor traces are analyzed for a potential transition of state. In addition, in the method and apparatus of the present invention, the victim traces under analysis, carry signals (e.g. current) to a storage device or to an output port and are in the proximity of aggressor traces that are transitioning.

The electronic systems implemented in accordance with the teaching of the present invention include a number of connected devices. Information is communicated to these devices on a data input. In addition there is a system clock that provides timing for the electronic system and device clocks, which are typically based on the system clock and provide timing information for specific devices. Lastly, in some devices such as storage devices there may also be control inputs such as an update input which along with the appropriate clock transition updates a storage device or a synchronous or asynchronous set/reset input which carries a set/reset signal to the storage device and causes to the storage device to set/reset. Therefore, an electronic system implemented in accordance with the teachings of the present invention includes electronic devices that may have several data inputs, a clock input and several control inputs.

In the method and apparatus of the present invention coupling efficiency is used to characterize the performance of the electronic system. The coupling efficiency is characterized as a ratio of the coupling capacitance of the aggressors to victims, divided by the total capacitance of the component under study. The total capacitance includes the capacitance coming from the aggressors as well as other capacitance such as capacitance to ground, to VDD (plus voltage), to the substrate and to non-aggressor signals.

The coupling efficiency is typically stated as a percentage. For example a coupling efficiency of 0.4 would suggest that the coupling from the aggressors could move the victim trace 40% of the way from a defined logic 0 to a defined logic 1 (e.g. VDD). As a result, if the victim trace is already sitting part of the way towards VDD, this may cause the victim trace to appear to be at another state (e.g. logical 0 or 1). For example, if the victim trace is already 30% of the way toward VDD, then a coupling efficiency of 0.4 may suggest that the victim trace may ultimately produce a signal that is 70% of the way toward VDD. If all the aggressors couple to the victim trace at the same time; the victim trace may carry a value that is closer to a logical 1, than the intended value of a logical 0. The storage device receiving the input from the victim trace may then change states because the storage device is receiving a signal that is close enough to a logical 1 (e.g. 70% of the way toward VDD) to be read as a logical 1.

It should be appreciated that the discussion above may be generalized. Therefore, the signal may start at zero and couple upward 40% of the way to logical 1. If 40% is above a trip point for the device, the device may store the incorrect data. The trip point is defined as the point at which a device reads a change of state (e.g. logical 0 or logical 1). For example, in an electronic system a trip point may be set at 50%, 60%, etc. Therefore, if the coupling is enough to make the input pass the gates trip point (e.g. 50%, 60%), the gate will read the input signal as a different signal and respond accordingly.

In the method and apparatus of the present invention, several approaches for simulating electronic systems are presented. The approaches for simulating the electronic systems include identifying key electronic devices, interrelating other electronic devices with the key electronic devices and simulation techniques which describe the real-word operation of electronic system.

In the method and apparatus of the present invention, specific devices are defined based on the operation of the devices under different conditions. The data on the operation of the devices is acquired from empirical analysis or from operational testing of the devices. The data includes operating or performance parameters and is stored in centrally or distributed libraries or databases. In addition, data on the performance of the devices, when the devices interact with other devices, is also acquired and maintained in the same way. Therefore, in the method and apparatus of the present invention, devices and circuits may be defined for simulation by accessing the device and circuit parameters from libraries and databases and structuring the devices in the configuration required for the simulation.

In addition, in the method and apparatus of the present invention, methods are presented for identifying failure in an electronic system. For example, storage devices are tested to determine failure in an electronic system. In addition, in accordance with the teachings of the present invention, real-world operation of the electronic circuit is simulated, by focusing on various failure mechanisms in the electronic system.

In one method of the present invention, performance of an electronic system is characterized by a table referred to as a vulnerability table. The vulnerability table is a table, which includes the coupling efficiency for an input (e.g. victim wire) to a device on one axis versus the line length of the victim wire on the other access. In addition, a vulnerability table is developed based on the drive size of the device driving (e.g. communicating electrical signals onto) the victim wire. Therefore, the vulnerability table may be thought of as a three dimensional table with the coupling efficiency on one axis, the length of the victim wire on another axis and the drive size of the device driving the victim wire on a third axis.

A vulnerability table is developed for the input of each device in the electronic system under study. As a result, the vulnerability table provides a device based signal integrity check. The vulnerability table is an indication of the potential for cross-coupling based on the coupling efficiency, line length of the victim wire and the drive strength of the gate driving the victim wire, where the drive strength is defined as amount of resistance in the gate when the gate is in the “on” state.

With the vast number of devices and the various inputs per device there are a number of failures that may occur in an electronic system. For example, signals may not reach a device at the correct time or the processing of data in the system by one device may cause another device to malfunction. The various malfunctions that may occur in an electronic system are often referred to as failure mechanisms.

In the method and apparatus of the present invention, failure mechanisms are used to characterize the electronic system for the purposes of simulation. For example, a storage device may include data inputs, a clock input and control inputs. In accordance with the teachings of the present invention one or more failure mechanisms may be associated with each type of input to a storage device.

In addition to vulnerability tables a vulnerability window is associated with each type of failure mechanism. A vulnerability window is a period of time during which cross-coupling onto an input to a storage device may cause the storage device to store incorrect data.

Specifically a storage device implemented in accordance with the teachings of the present invention includes one or more failure mechanisms associated with each input. For example, a storage device includes two failure mechanisms associated with the data input, a failure mechanism associated with the clock input and a two failure mechanisms associated with the control input. Each failure mechanism is used to characterize the behavior of the electronic system for the purposes of simulation.

In the method and apparatus of the present invention, there are two failure mechanisms associated with the data input to a storage device. The first failure mechanism is referred to as a data flow failure mechanism. The second failure mechanism is referred to as the overshoot/undershoot failure mechanism. Both failure mechanisms are used in the method and apparatus of the present invention to characterize and simulate signal integrity in an electronic system.

In the data flow failure mechanism noise (e.g. the result of cross-coupling) occurs on a data input line during the data input vulnerability window and causes the storage device to store the wrong data. If the data input is at a logical 0, a noise spike may change the data from a logical 0 value to a value between logical 0 and logical 1. If the noise occurs on the data input long enough or causes the data input to move high enough toward a logical 1 value, the storage device may store a logical 1 rather than a logical 0. The same thing may occur in reverse. If the data input is at a logical 1, a noise spike may change the data from a logical 1 value to a value between logical 1 and logical 0. If the noise occurs on the data input long enough or causes the data input to move low enough toward a logical 0 value, the storage device may store a logical 0 value rather than a logical 1.

The data flow failure mechanism occurs on all data inputs on storage devices. An illustrative embodiment of a storage device follows however, it should be appreciated that the method and apparatus of the present invention is not limited to the following implementation. Consider a storage device that uses pass only input Field Effect Transistors (FET's). In a pass only input FET there is an n-type FET and a p-type FET connected in parallel. The two sources of the FET's are connected and the two drains of the FET's are connected. A data input goes to the source and a clock input goes to the gate of the n-type FET. The clock inverted goes to the gate of the p-type FET. The drain of the n-type FET and the drain of the p-type FET are connected and go to the storage device. The storage device may include two back-to-back inverters. One inverter is a strong inverter and the second inverter is a weak inverter. The strong inverter is capable of overdriving the weak inverter, which is gated on the opposite phase of the clock input.

As mentioned earlier, a storage device may change its internal state when its clock input changes. The time period, during which the input must be stable before the clock transition, is the setup time. The time period that the data input must remain stable after the clock transition is the hold time. The circuit driving the victim wire will bring the wire back to the proper state resulting in a noise spike that has a short duration. The time required to bring the wire or trace back to the proper state, is known as the recovery time. Therefore, the victim vulnerability window for the data flow failure mechanism is defined by equations (1) and (2) given below, where T1 and T2 define the boundaries of the victim vulnerability window.

T1=clock transition−set up time−recovery time (1)

T2=clock transition+hold time (2)

In the method and apparatus of the present invention, any transition (e.g. noise) that occurs within the victim vulnerability window is considered an aggressor (e.g. cross coupling from aggressor to victim). When assessing the integrity of the data input to a storage device using the data flow failure mechanism, a simulator determines whether a transition signal falls within the victim vulnerability window. Should the transition signal fall within the victim vulnerability window, the potential for cross-coupling is very high.

In the method of the present invention, a mapped vulnerability window is then created for any signal that has a logic path to an input (e.g. gate drives the signal on the data input line) of a storage device. Therefore if a gate is communicating signals on a data input to a storage device, a mapped vulnerability window is created for the input signal of the gate. The mapped vulnerability window is based on the victim vulnerability window of the storage device.

As mentioned previously, the signals in an electronic system take time to propagate to every device in the system. In addition, the signals generated by a gate may take time to propagate through the system. Specifically, the signals generated from a gate may arrive at a storage device receiving that signal, with a maximum delay time or with a minimum delay time. The delay time may be a function of the resistance of the wire, the capacitance on the wire at a specific time and other factors.

The mapped vulnerability window of a gate is a function of the victim vulnerability window for a storage device and the time required to communicate a signal from the gate to the storage device. For discussion purposes the boundary of the mapped vulnerability window will be defined by the variables T1_{mapped} and T2_{mapped}. The first mapped boundary T1_{mapped} is a function of the maximum delay time and the victim vulnerability window. The second mapped boundary T2_{mapped} is a function of the minimum delay time and the victim vulnerability window. The first mapped boundary and the second mapped boundary are represented by equations (3) and (4) given below.

T1_{mapped}=T1−maximum delay time

T2_{mapped}=T2−minimum delay time

A mapped vulnerability window based on the data flow failure mechanism, is created for each gate on a wire that provides input to a storage device. The maximum delay and the minimum delay are computed based on the parameters of the device and other factors in the simulation. When multiple devices are on the wire, the delay time is computed taking the other devices on the wire into account.

As a result of the foregoing, each device is analyzed and simulated based on the data flow failure mechanism. Therefore, at this point in the discussion, each device is characterized based on the three-dimensional vulnerability table identified above and the mapped vulnerability window for the data flow failure mechanism. The three-dimensional vulnerability table for the device such as a gate is a function of the coupling efficiency, the length of the victim wire and the driver size of the gate in use. The mapped vulnerability window is a function of the vulnerability window of a storage device receiving input from the device under study and the signal delay in the wire. As a result, in the method and apparatus of the present invention a gate is characterized by vulnerability tables, a timing window and mapped vulnerability windows.

A subset of storage devices may be characterized by a failure mechanism on their data input, known as the overshoot/undershoot failure mechanism. In the overshoot/undershoot failure mechanism, the storage device is turned off, meaning that the storage device is stable and storing a value such as a logical 0 or a logical 1. For discussion purposes, assume that the data input to the storage device has a value of logical 0 and there is a logical 1 stored in the storage device. In addition, assume that the pass FET is off, so the storage device does not receive the logical 0 on the data input. In other words we are at a time in the operation of the storage device, where we don't want to write a value into the storage device (e.g. we don't want the storage device to store a new value). The logical 1 has been stored into the storage device from a previous load and during operation we would prefer that the storage device maintain (e.g. store) the logical 1. For this example, we assume that when the pass FET device is turned off, the value on the data input line is a logical 0. Therefore, the vulnerability window occurs when the storage device input is turned off.

Given the scenario defined above the overshoot/undershoot problem occurs as follows. If the data input is coupled negative so that it goes below logical zero, the data input may turn on the pass input of the storage device. As a result, in the overshoot/undershoot failure mechanism the data input turns on the pass input to the storage device. The pass input to the storage device is not turned on hard, but some current starts to flow. The logical one (e.g. 5 volts) that is stored in the storage device starts to discharge (e.g. bleed-off). As the logical 1 in the storage device discharges (e.g. bleeds-off), the storage device may change states from a logical 1 to a logical 0. This is an example of the undershoot failure mechanism.

The overshoot failure mechanism occurs in a similar manner. If the data input is coupled positive so that it goes above logical 1 (e.g. plus 5 volts or VDD), the data input will turn on the pass input to the storage device. So in this failure mechanism the data input turns on the pass input to the storage device. The pass input to the storage device is not turned on hard, but some current starts to flow. As a result, the storage device starts to store a charge. As the storage device stores the charge, the storage device may change states from a logical 0 to a logical 1. This is an example of the overshoot failure mechanism.

Since the overshoot/undershoot failure mechanism may occur at anytime that the clock is off, the vulnerability window for the overshoot undershoot failure mechanism is the time period when the clock is off. For the purposes of discussion, the vulnerability window for the overshoot/undershoot failure mechanism may be bounded by T_{o/u1} and T_{o/u2.}; where T_{o/u1} and T_{o/u2} define the period where a storage device is susceptible to cross-coupling as a result of the overshoot/undershoot failure mechanism.

Based on the vulnerability window for the overshoot/undershoot failure mechanism any noise that occurs within the vulnerability window for the overshoot/undershoot failure mechanism is aggressor noise. When assessing the integrity of signals, a simulator is able to look at signal transitions in the electronic system to determine if a transition fall within the vulnerability window for the overshoot/undershoot failure mechanism. Should a transition fall within the vulnerability window for the overshoot/undershoot failure mechanism, the potential for cross-coupling is very high.

A storage device may also be analyzed based on a clock failure mechanism. A failure mechanism may occur on a clock input to a storage device, if the clock is in the off state and noise appears on the clock input to the storage device. If the clock is at logical 1 and noise appears on the clock input to the storage device, the clock may move to a logical 0. In the alternative, if the clock is at a logical 0 and noise appears on the clock input to the storage device, the clock may move to a logical 1. As a result, the storage device may turn on or off and store the wrong data at the wrong time.

In another embodiment of the present invention the storage device may be implemented by a master slave register. A master slave register is configured with two latches located side-by-side. The latches are gated by opposite edges of a clock transition. As a result, on the rising edge of the clock transition information may be stored in one of the latches and information may be stored in the other latch on the falling edge of the clock transition. Therefore, the master slave pair of latches functions like an edge triggered D flip flop. As a result, a noise on the clock at any time may cause the storage element to store the wrong data.

Since the clock failure mechanism may occur at anytime, the vulnerability window for the clock failure mechanism is infinite (e.g. may occur anytime). For the purposes of discussion, the vulnerability window for the clock failure mechanism may be shown by the variable T_{clk}, which would have a time value that is infinite

A mapped vulnerability window, which is based on the clock input to the storage device, is then created for each device that provides input to the storage device. Therefore if a gate is communicating signals on a wire, which serves as a clock input to the storage device, a mapped vulnerability window is created for the gate.

The mapped vulnerability window, which is based on the clock failure mechanism, is a function of the vulnerability window of the clock failure mechanism. For the purposes of discussion, the mapped vulnerability window, which is based on the clock failure mechanism, will be defined by the variable T3_{mapped}. Since the vulnerability window for the clock failure mechanism is infinite, the mapped vulnerability window associated with the clock failure mechanism is infinite and may be represented by equation (5) given below.

T3_{mapped}=T_{clk1} (5)

A mapped vulnerability window for the clock failure mechanism is created for each component on a wire that provides clock input to the storage device. Since the vulnerability window associated with the clock failure mechanism is infinite, the mapped vulnerability window associated with each gate in the system will also be infinite.

As a result of the foregoing, the simulation of a device (e.g. gate) generating a signal which ultimately serves as a clock input to a storage device, is a function of the three dimensional vulnerability table, a mapped vulnerability window based on the data flow failure mechanism and a mapped vulnerability window based on the clock failure mechanism.

In addition to the clock input, the storage device may be analyzed based on a control line failure mechanism. In the present invention two control line failure mechanisms are identified, a synchronous control line failure mechanism and an asynchronous control line failure mechanism.

As an example, a synchronous control line can cause a storage device to reset/set or update. In the synchronous control failure mechanism noise (e.g. the result of cross-coupling) occurs on a synchronous control line during the synchronous control vulnerability window and causes the storage device to store the wrong data. If the synchronous control line is at a logical 0, a noise spike may change the synchronous control line from a logical 0 value to a value between logical 0 and logical 1. If the noise occurs on the synchronous control line long enough or causes the synchronous control line to move high enough toward a logical 1 value, the synchronous control line may cause the storage device to store a logical 1 rather than a logical 0. The same thing may occur in reverse. If the synchronous control line input is at a logical 1, a noise spike may change the synchronous control line from a logical 1 value to a value between logical 1 and logical 0. If the noise occurs on the synchronous control line long enough or causes the synchronous control line to move low enough toward a logical 0 value, the storage device may store a logical 0 value rather than a logical 1.

As mentioned earlier, a storage device may change its internal state when its clock input changes. The time period, during which the input must be stable before the clock transition, is the setup time. The time period that the data input must remain stable after the clock transition is the hold time. The circuit driving the victim wire will bring the wire back to the proper state resulting in a noise spike that has a short duration. The time required to bring the wire or trace back to the proper state, is known as the recovery time. Therefore, the vulnerability window for the synchronous control failure mechanism is defined by equations (6) and (7) given below, where T_{synch-control1} and T_{synch-control2} define the boundaries of the vulnerability window associated with the synchronous control line failure mechanism.

T_{synch-control1}=clock transition−set up time−recovery time (5)

T_{synch-control2}=clock transition+hold time (6)

In the method and apparatus of the present invention, any transition (e.g. noise) that occurs within the synchronous control line vulnerability window is considered an aggressor (e.g. cross coupling from aggressor to victim). When assessing the signal integrity of the synchronous control input to a storage device, a simulator determines whether a transition signal fall within the vulnerability window. Should the transition signal fall within the vulnerability window, the potential for cross-coupling is very high.

In the method of the present invention, a mapped vulnerability window is then created for any signal that has a logic path to the synchronous control line input of a storage device. Therefore if a gate is communicating signals on a synchronous control line input to a storage device, a mapped vulnerability window is created for the input signal of the gate. The mapped vulnerability window is based on the vulnerability window associated with the synchronous control line failure mechanism.

The mapped vulnerability window of a gate is a function of the victim vulnerability window for a storage device and the time required to communicate a signal from the gate to the storage device. For discussion purposes the boundary of the mapped vulnerability window will be defined by the variables T4_{mapped} and T5_{mapped}. The first mapped boundary T4_{mapped} is a function of the maximum delay time and the vulnerability window associated with the synchronous control line failure mechanism. The second mapped boundary T5_{mapped} is a function of the minimum delay time and the vulnerability window associated with the synchronous control line failure mechanism. The first mapped boundary and the second mapped boundary are represented by equations (7) and (8) given below.

T4_{mapped}=V_{synch-control1}−maximum delay time (7)

T5_{mapped}=V_{synch-control2}−minimum delay time (8)

A mapped vulnerability window based on the synchronous control failure mechanism, is created for each gate on a wire that provides input to a storage device. The maximum delay and the minimum delay are computed based on the parameters of the device and other factors in the simulation. When multiple devices are on the wire, the delay time is computed taking the other devices on the wire into account.

As a result of the foregoing, each device is analyzed and simulated based on the synchronous control failure mechanism. Therefore, at this point in the discussion, each device is characterized based on the vulnerability tables, a mapped vulnerability window based on the data flow failure mechanism, a mapped vulnerability window based on the clock failure mechanism, and a mapped vulnerability window based on the synchronous control line failure mechanism.

A storage device may also be analyzed based on an asynchronous control line failure mechanism. An asynchronous control line signal causes the storage device to reset/set or update regardless of the state of the clock. The asynchronous control line may be used for operations such as a power on, etc. A failure mechanism may occur on an asynchronous control line input to a storage device, if the asynchronous control line is in the off state and noise appears on the asynchronous control line input to the storage device. If the asynchronous control line is at logical 1 and noise appears on the asynchronous control line input to the storage device, the asynchronous control line may move to a logical 0. In the alternative if the asynchronous control line is at a logical 0 and noise appears on the asynchronous control line input to the storage device, the asynchronous control line may move to a logical 1. As a result, the storage device may turn on or off and store the wrong data at the wrong time.

Since the asynchronous control line failure mechanism may occur at anytime, the vulnerability window for the asynchronous control line failure mechanism is infinite (e.g. may occur anytime). For the purposes of discussion, the vulnerability window for the asynchronous control line failure mechanism may be shown by the variable T_{asynch-control}, which has a time value that is infinite

A mapped vulnerability window, which is based on the asynchronous control line input to the storage device, is then created for each device that provides input to the storage device. Therefore if a gate is communicating signals on a wire, which serves as a asynchronous control line input to the storage device, a mapped vulnerability window is created for the gate. The mapped vulnerability window is based on the vulnerability window for the asynchronous control line failure mechanism.

The mapped vulnerability window, which is based on the asynchronous control line failure mechanism, is a function of the vulnerability window of the asynchronous control line failure mechanism. For the discussion purposes, the mapped vulnerability window which is based on the asynchronous control line failure mechanism will be defined by the variable T6_{mapped}. Since the vulnerability window for the asynchronous control line failure mechanism is infinite, the mapped vulnerability window associated with the asynchronous control line failure mechanism is infinite and may be represented by equation (9) given below.

T6_{mapped}=T_{asynch-control} (9)

A mapped vulnerability window for the asynchronous control line failure mechanism is created for each component on a wire that drives the asynchronous control line input to the storage device. When multiple devices are on the wire, each of the devices would have a mapped vulnerability window, which is infinite, associated with the device.

As a result of the foregoing, the simulation of a component (e.g. gate) generating a signal which ultimately arrives as an asynchronous control line input to a storage device, is a function of the three dimensional vulnerability table, a mapped vulnerability window based on the data flow failure mechanism, a mapped vulnerability window based on the clock failure mechanism, a mapped vulnerability window based on the synchronous control line failure mechanism and a mapped vulnerability window based on the asynchronous control line failure mechanism.

Each of the tables, vulnerability windows and mapped vulnerability windows are stored and associated with each device in the electronic system. An analysis is made of the value of each table and window associated with each device. For example, should a table associated with a device store a value that is greater than a user defined acceptable value, this is notification that a signal integrity problem may exist. In addition, because these tables and windows are associated with specific failure mechanisms, the specific signal integrity problem may also be identified.

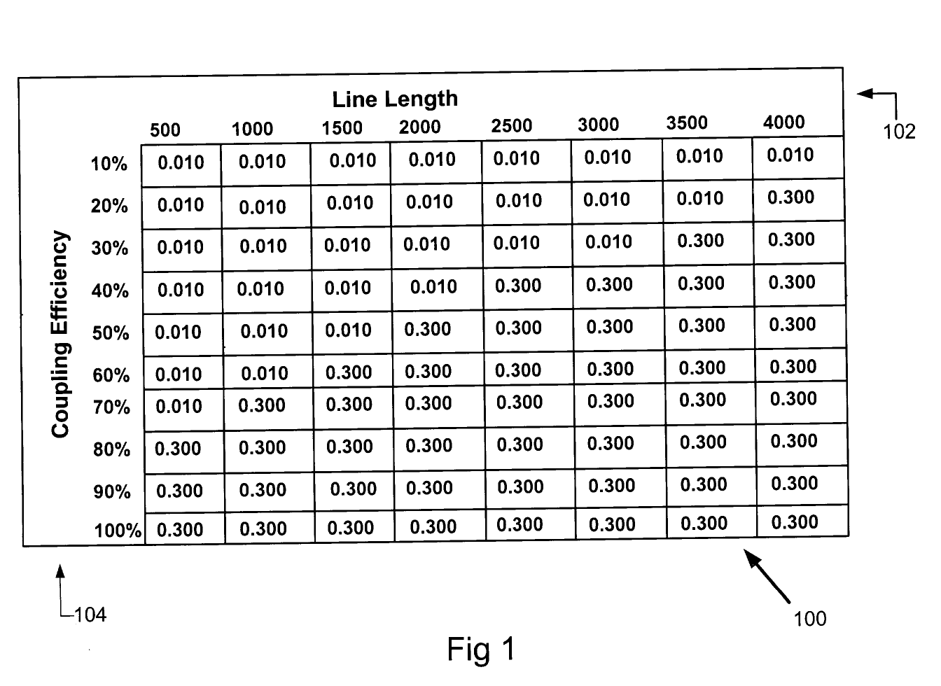

FIG. 1 displays a vulnerability table 100 used in the present invention. As mentioned above a plurality of vulnerability tables are associated with each electronic device in the electronic system. For example, in FIG. 1 the line length is shown as 102. The line length 102 includes a range of values from 500 microns to 4000 microns. The coupling efficiency is shown as 104. The coupling efficiency is denoted as a percentage. A range of coupling efficiency values from 10% to 100% are shown as 104. It should be noted that the range of coupling efficiency values, are incremented by 10%, however, any range may be used. In addition, it should also be appreciated that the range may be incremented by any user-defined value. Within the vulnerability table 100, each cell of data denotes the size of the noise spike on the victim wire.

For example using an inverter, the vulnerability table would represent the impact that noise on the input of the inverter would have on the output of the inverter. Therefore, each cell in the vulnerability table represents the size of the noise spike on an output, as a result of noise that matches the constraints that were given at the input. The constraints include the drive size, line length and coupling efficiency.

In FIG. 1, a coupling efficiency of 20% and an input line length of 2500 microns will result in a noise spike of 0.01 on the output of the inverter. The 0.01 represents the percentage of the noise spike between ground and VDD. Therefore a value of 0.01 identifies a signal that has moved 10% of the range between ground and VDD. With 70%, percent coupling and a line length of 300 the resulting noise spike is 0.30 or the signal would move 70% of the way between ground and VDD. It should also be appreciated that in the method and apparatus of the present invention, when a storage element is under analysis, the noise spike represented in a cell of the two-dimensional vulnerability table 100, may be measured at an internal node or an external node of the storage device.

A three-dimensional vulnerability table is created by creating a two-dimensional vulnerability table as shown in table 100, for a range of drive strengths, where the drive strength is proportional to the “on” resistance of the driving gate. Therefore, a three-dimensional vulnerability table is a function of the line length of the victim wire, the coupling efficiency of the victim wire and the drive strength of a gate driving the victim wire.

After the noise spike is determined using the vulnerability table shown in FIG. 1 a simulation system (e.g. computer running computer instructions) determines whether the noise spike passes a user-defined threshold. The user-defined threshold enables an end-user to control the level of granularity used to simulate the electronic system. For example using FIG. 1, a line length of 3500 and a coupling efficiency of 80%, results in a noise spike of 0.300. If the user defined threshold for flagging this circuit or device is below 0.30% the logic gates or circuits associated with this noise spike will be identified for further processing or analysis.

Although item 100 of FIG. 1 displays two-dimensional vulnerability relationship (e.g. table), it should be appreciated that the vulnerability table implemented in accordance with the teachings of the present invention may be a range of two dimensional vulnerability tables or a three dimensional vulnerability relationships (e.g. tables).

To generate the vulnerability tables, a gate driving signals on a trace or wire is defined by driver size. The parameters and operations of the gate are determined based on data acquired or stored in libraries or databases. It should be appreciated that although the invention starts with one gate (e.g. driver size) the methods discussed below are then implemented for a range of gates each with different driver sizes.

Once a specific gate has been defined, a range of traces or wires of different line lengths are run into the gate. After the driver size for a specific gate has been identified, a model is used to generate a range of different line lengths for use as input to the gate. Equivalent line lengths or traces are then defined and are simulated to run along side of the input to the gate. Capacitance and inductances are modeled between the equivalent line lengths and the line lengths that simulate inputs to the gate. One or more equivalent line lengths may be provided for each line length that serves as an input to the gate, as a result, a range of equivalent line lengths is developed.

The established model which includes a gate at a specific driver size, a range of line lengths serving as inputs to the gate and a range of equivalent line lengths, is then modified to increase or decrease the coupling efficiency. As a result of the modification, a simulation is run for a range of coupling efficiencies (e.g. item 104 on FIG. 1). Each coupling efficiency value is used to simulate the amount of noise on an output or input on a gate; or whether a storage device receiving signals from the gate stores the incorrect data. The noise value is stored as the data in FIG. 1. Once the noise is determined for all coupling efficiencies, a new line length is defined and the process is repeated. Once the process is completed for all the line lengths and all the coupling efficiencies a new driver size is established and the process is repeated.

A range of driver sizes associated with a gate is used to develop a three-dimensional vulnerability table. The range of driver sizes and their operation is defined using libraries and databases, which store gate and storage device parameters. The line length for an input to the gate is then defined. The coupling efficiency is calculated for the driver size and the line length (e.g. this results in the first noise value that will be used to fill in the vulnerability table). The noise value for each cell in the table is calculated by changing the coupling efficiencies. The coupling efficiencies typically range from 0% to 100%. The noise calculations associated with each coupling efficiency value, fills in a column associated with a line length. The line length is then changed and the coupling efficiency is incrementally increased once again. A second column of noise values results. This process is continued until a two-dimensional vulnerability table 100 of FIG. 1 is generated.

A two-dimensional vulnerability table is generated by defining the driver size of a gate and then using a range of line lengths and a range of coupling efficiencies to calculate the various noise values associated with each. The driver size of the gate is then changed and a new driver size is defined for the gate. Once the new driver size is defined for the gate the same process is repeated. As a result, in the method and apparatus of the present invention, a three-dimensional vulnerability table is generated.

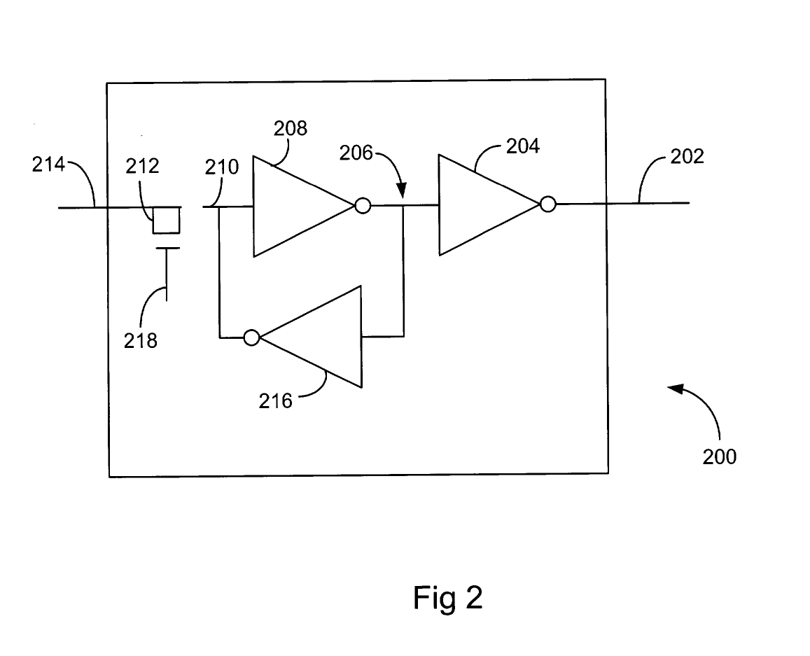

FIG. 2 displays a storage element used in the method and apparatus of the present invention. However, it should be appreciated that the storage element 200 is a representative storage element and that another digital storage element may be used and still remain within the scope of the present invention. In the method and apparatus of the present invention an internal node, an external node or a comparison between nodes of the storage element 200 are used during simulation.

In FIG. 2 inverters 208, 216 and 204 are shown. An output line 202 is shown and a data input line is shown as 214. In addition, a clock signal 218 is applied to a switch 212. When the switch 212 is open, a signal appears at the input to the inverter 208 as shown at 210

An inverter takes a high signal and converts it to a low signal and a low signal and converts it to a high signal. Inverters 208 and 216 are configured as a cross-coupled (e.g. back-to-back) inverter pair. When two inverters are configured back-to-back the device stores the state held between the two inverters (e.g. steady state condition). Inverter 216 is designed as a weak inverter. When the clock signal 218 is off, the data input signal 214 does not reach the back-to-back inverter. Therefore, the weak inverter 216 will work in conjunction with inverter 208 to maintain whatever piece of data is in back-to-back inverter at that time. When the clock signal 118 is on, a logical signal on the data input 214 is allowed to go through the switch 212. The data will overdrive the bottom inverter 216 causing the back-to-back inverter to respond to the data on the data input 214. This has the potential of changing the state of the storage device 200. Inverter 204 is then placed on a data output path so that the data input 214 and the data output 202 will match.

In the method and apparatus of the present invention, an error is defined as an invalid state on an external node or and internal node of a storage device. Therefore, in the method and apparatus of the present invention, the storage device 200 is tested for invalid data. The storage device 200 is tested for invalid data on an output line shown as 202 or on an internal node shown as 206.

The data flow failure mechanism is based on the victim vulnerability window. The victim vulnerability window defines a time at which noise on the data input 214 will cause the back-to-back inverter 208/216 to store the wrong data.

Using FIG. 2. the overshoot/undershoot failure mechanism occurs as follows. Data is stored in the back-to-back inverter 208/216. The data input 214 has a logical 0 value. However the data input signal 214 does not reach the back-to-back inverter 208/216, because the switch 112 is closed. If the data input becomes a victim and is coupled negative so that it goes below logical zero, the data input may turn on the switch 112 and as a result may change the state of the storage device. The storage device is not turned on hard, but some current starts to flow. A logical 1 that is stored in the storage device starts to bleed out to location 206. As the logical 1 in the storage device bleeds out, the storage device may change states from a logical 1 to a logical 0 which is at the input to the storage device as shown at position 210. This is an example of the undershoot failure mechanism.

The overshoot failure mechanism occurs in a similar manner. Using FIG. 2, a logical 0 is stored in the back-to-back storage device 208/216. In addition, a logical 1 is on the input line 214. If the data input 214 is coupled positive so that it goes above a logical 1 the data input will turn on the switch 212. The back-to-back inverter 208/216 is not turned on hard, but some current starts to flow. As a result, the logical 0 that is stored in the storage device starts to bleed out. As the logical 0 in the storage device bleeds out the storage device may change states from a logical 0 to a logical 1. This is an example of the overshoot failure mechanism.

The control failure mechanism and the clock failure mechanisms are both very similar. If the clock signal 218 is at logical 0 it may move to a logical 1. In the alternative if the clock is at a logical 1 it may move to a logical 0. As a result, the switch 212 may turn on or off at the wrong time and allow data 214 to enter the back-to-back inverter 208/216 at the wrong time. The vulnerability window for the clock failure mechanism is infinite.

The synchronous control failure mechanism is based on the victim vulnerability window. The victim vulnerability window defines a time at which noise on a control line input (not shown) will cause the back-to-back inverter 208/216 to store the wrong data.

The asynchronous control line input to a storage device also experiences a similar problem. As an example, an asynchronous control line (not shown) can cause a storage device to set/reset or update. As a result, a signal on the asynchronous control line can turn the storage device on or off. If the asynchronous control line is positioned at a logical 1 or a logical 0, noise on the asynchronous control line can change the logical 1 to a logical 0 and vice versa. As a result, the asynchronous control line may signal a set/reset to the back-to-back storage device 208/216 and cause the back-to-back storage device 208/216 to store (e.g. latch) the wrong data at the wrong time. Since the asynchronous control failure mechanism may occur at anytime the vulnerability window for the asynchronous control failure mechanism may occur at any time.

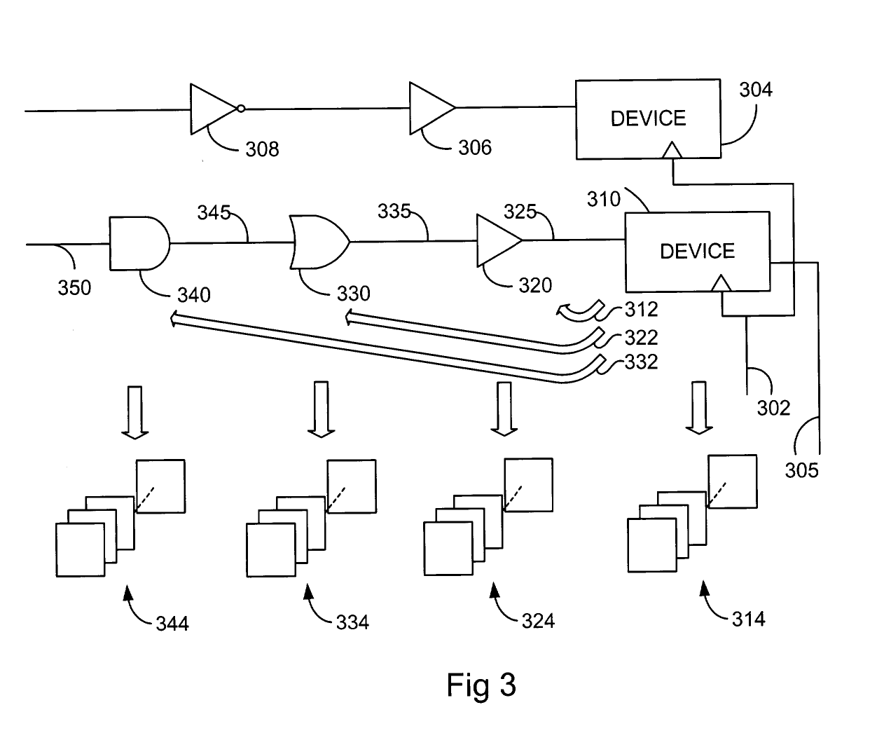

An electronic system is shown in FIG. 3. Storage devices are shown as 304 and 310. A signal or transition is processed through inverter 308 and buffer 306 before reaching storage device 304. A transition signal is processed through NAND gate 340, NOR gate 330 and buffer 320 before reaching storage device 310. Therefore, NAND gate 340, NOR gate 330 and buffer 320 are driving signals toward storage device 310. A clock input for storage device 304 and 310 is shown as 302. Lastly, a control signal input for storage device 310 is shown as 305.

In the method and apparatus of the present invention each storage device includes a number of vulnerability tables and vulnerability windows. For example, storage device 310 may include a vulnerability window associated with the data input to the storage device, a vulnerability window associated with the clock input of the storage device and a vulnerability window associated with the control input of the storage device. In addition, each gate such as the buffer 320, the NOR gate 330 and the NAND gate 340 would include a vulnerability table associated with different gate sizes. The multitude of vulnerability tables and vulnerability windows associated with storage device 310 are graphically displayed as 314. The multitude of vulnerability windows and vulnerability tables associated with gates 320, 330 and 340 are graphically displayed by 324, 334 and 344 respectively.

As previously stated, in addition to a vulnerability table, each storage device and each gate would also include vulnerability windows. The vulnerability windows are a function of the failure mechanisms under analysis. For example, in storage device 310 two vulnerability windows would be present for the data input 325 failure mechanism, a vulnerability window would be associated with the clock input 302 failure mechanism and a vulnerability window would be associated with the control input 305 failure mechanism.

The vulnerability window for the storage device 310 is dependent on the failure mechanism that is being simulated. In a storage device the failure mechanism associated with the data input shown as 325 are the data flow failure mechanism and the overshoot/undershoot failure mechanism. In addition, there is a failure mechanism associated with the clock input 302 and a failure mechanism associated with the control input 305.

The vulnerability window is an indication of the time period during which cross coupling may occur. As mentioned earlier the vulnerability window associated with the data flow failure mechanism for storage device 310 is the period of time between T1 and T2.

A mapped vulnerability window is then created for each device that provides input to storage device 310. For example, in FIG. 3 a mapped vulnerability window is created for each gate such as the buffer 320, the NOR gate 330 and the NAND gate 340. The mapped vulnerability window is based on the vulnerability window of a storage device 310.

As mentioned earlier, the signals in an electronic system take time to propagate to every component in the system. In addition, the signals generated by a gate may take time to propagate through the system. Specifically, the signals generated from a gate may arrive at a storage device receiving that signal with a maximum delay time or with a minimum delay time. The delay time may be a function of the resistance of the wire, the capacitance on the wire at a specific time and other factors.

In FIG. 3 signals or transitions will have a time delay in traversing through input wire 325. Transitions will also have a time delay when traversing across wires 335 and 345. Therefore starting with the vulnerability window of storage device 310, a mapped vulnerability window is produced.

The mapped vulnerability window of a buffer 320 is a function of the vulnerability window of the storage device 310 and the time required to communicate a signal from the buffer, through the wire 325, to the storage device 310. As mentioned earlier the mapped vulnerability window is defined by the variables T1_{mapped} and T2_{mapped}. The first mapped boundary and the second mapped boundary are represented by equations (3) and (4) given above.

As a result, the vulnerability window associated with storage device 310 is mapped as shown by 312, back to buffer 320 to create a mapped vulnerability window associated with buffer 320. The mapped vulnerability window is a function of the vulnerability window (T1, T2) associated with a failure mechanism, of storage device 310.

The mapped vulnerability window of a failure mechanism, for the NOR gate 330 (e.g. second gate on the wire) is a function of the vulnerability window of the storage device 310 and the time required to communicate a signal through the NOR gate, through the wire 335, through the buffer 320, through the wire 325 to the storage device 310. The mapped vulnerability window for the NOR gate 330 may be defined by the variables T_{2nd-gate1} and T_{2nd-gate2}. The first mapped boundary T_{2nd-gate1} is defined as the first boundary minus the maximum delay time. The second mapped boundary T_{2nd-gate2} is defined as the second boundary minus the minimum delay time. The first mapped boundary and the second mapped boundary for the second gate (e.g. 330) are represented by equations (11) and (12) given below.

T_{2nd-gate1}=T₁−maximum delay time (10)

T_{2nd-gate2}=T₂−minimum delay time (11)

Where the maximum and minimum delays are the maximum time required to communicate a signal through 335, through the buffer 320, through the wire 325, to the storage device 310 and the minimum time required to communicate a signal through wire 335, through the buffer 320, through the wire 325, to the storage device 310. As a result, the timing window associated with storage device 310 is mapped as shown by 322, back to the NOR gate 330 to create a mapped vulnerability window associated with NOR gate 330.

The mapped vulnerability window of the failure mechanism for the NAND gate 340 is a function of the vulnerability window of the storage device 310 and the time required to communicate a transition, through the NAND gate 340, through the wire 345, through the NOR gate 330, through the wire 335, through the buffer 320, through the wire 325, to the storage device 310. The mapped vulnerability window for the NAND gate 340 may be defined by the variables T_{3rd-gate1} and T_{3rd gate2}. The first mapped boundary of the third gate in the sequence, T_{3rd-gate1}, will be defined as the first boundary (T1) minus the maximum delay time. The second mapped boundary T_{3rd-gate2} will be defined as the second boundary (T2) minus the minimum delay time. The first mapped boundary and the second mapped boundary are represented by equations (12) and (13) given below.

T_{3rd-gate1}=T₁−maximum delay time (12)

T_{3rd-gate2}=T₂−minimum delay time (13)

Where the maximum and minimum delay times are the maximum and minimum times required to communicate a signal transition through the wire 345, through the NOR gate 330, through the wire 335, through the buffer 320, through the wire 325, to the storage device 310. As a result, the timing window associated with storage device 310 is mapped as indicated by 332, back to the NAND gate 340 to create a mapped vulnerability window associated with the data flow failure mechanism.

Mapped vulnerability windows are also created based on the clock failure mechanism. A similar procedure as shown above would be performed to create a mapped vulnerability window based on the clock vulnerability window. For example, equations (14) given below would be used. T13_{mapped} represents the boundaries of a vulnerability window associated with the clock failure mechanism. Since the vulnerability window for the clock 302 is infinite. The mapped vulnerability window for any gates (not shown) on the clock input would also be infinite.

T13_{mapped}=T_{clk1} (14)

Mapped vulnerability windows are also created based on the control failure mechanism. A similar procedure as shown above would be performed to create a mapped vulnerability window based on the control vulnerability window. In FIG. 3 a control input is shown as 305. If the control input 305 is a synchronous control input, a mapped vulnerability window would be created for each gate (not shown) feeding control input 305. For example, equations (15) and (16) given below would be used. T14_{mapped} and T15_{mapped} would represent the boundaries of a vulnerability window associated with the synchronous control failure mechanism.

T14_{mapped}=T_{control1}−maximum delay time (b 15)

T15_{mapped}=T_{control2}−minimum delay time (16)

Mapped vulnerability windows are also created based on the asynchronous control failure mechanism. A similar procedure as shown above would be performed to create a mapped vulnerability window based on the asynchronous control vulnerability window. In FIG. 3 a control input is shown as 305. If the control input 305 is an asynchronous control input, a mapped vulnerability window would be created for each gate (not shown) feeding asynchronous control input 305. In addition, since the vulnerability window for the asynchronous control failure mechanism is infinite, the mapped vulnerability windows would be infinite. For example, equation (17) given below would be used. T17_{mapped} would represent the vulnerability window associated with the asynchronous control failure mechanism.

T17_{mapped}=T_{asynch-control} (17)

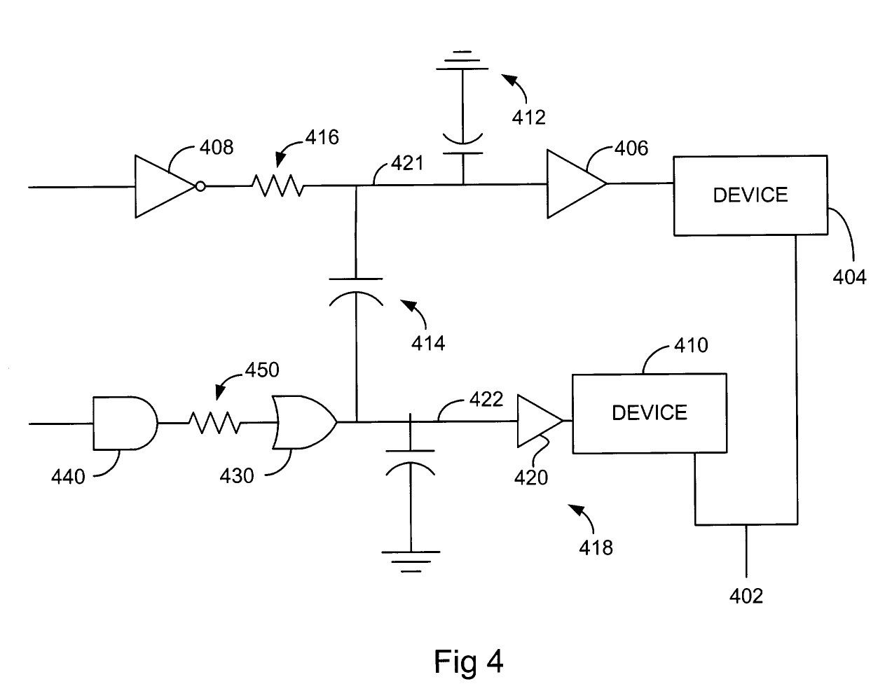

FIG. 4 displays and extracted diagram of the circuit of FIG. 3. In FIG. 4 the storage devices 404 and 410 correspond to the storage devices 304 and 310. The gates 406, 408, 420, 430 and 440 correspond to gates 306, 308, 320, 330 and 340 of FIG. 3. A clock 420 corresponds to clock 302 of FIG. 3 and provides timing information to the storage devices 404 and 410. Resistance in the wire of the circuit is shown as 416 and 450. In addition capacitance to ground is shown as 412 and 418. In the method and apparatus of the present invention wire 421 couples onto wire 422. The coupling is a capacitive coupling as shown by capacitor 414.

In the extracted circuit of FIG. 4 wire 421 would be considered the aggressor wire and wire 422 would be considered the victim wire. As such, a cross coupling onto victim wire 422 may cause storage device 410 to change a state and produce the wrong data output. As mentioned earlier, the change of state may be measured at an internal node or an external node of the storage device.

The extracted circuit shown in FIG. 4 is used to simulate the electronic circuit. The vulnerability tables are used to alert the simulator of cross-coupling problems. An extracted circuit is then developed which uses a capacitor to simulate the cross-coupling problem. In addition, other performance related features such as resistance in the wire and capacitance to ground are also shown. The extracted circuit is then used to simulate the performance of the actual circuit in the electronic system.

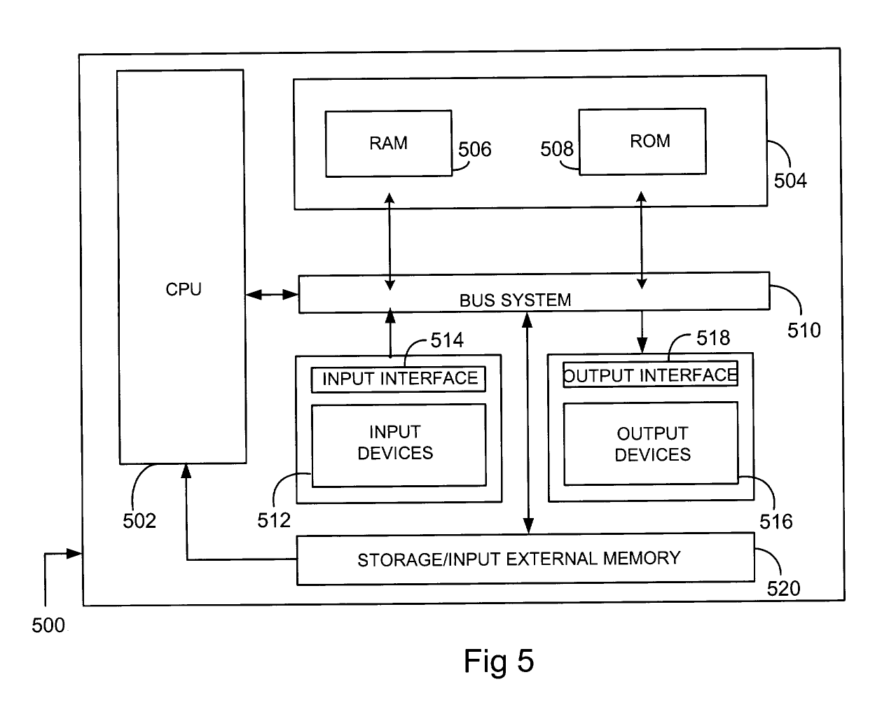

The method and apparatus of the present invention may be implemented using a multifunction computer. The method of the present invention may be accomplished by performing simulations in hardware, software or in a combination of the two. FIG. 5 is a block diagram of a computer 500 implementing the software methodology of the present invention. In FIG. 5 a central processing unit (CPU) 502 functions as the brains of the computer 500. Internal memory 504 is shown. The internal memory includes short term memory 506 and long term memory 508. The short term memory 506 may be Random access memory (RAM) or a memory cache used for staging information. The long term memory 508 may be a read only memory or an alternative form of memory used for storing information. A bus system 510 is used by the CPU 502 to control the access and retrieval of information from short term memory 506 and long term memory 508.

Input devices such as joy stick, keyboards or a mouse are shown as 512. The input devices 512 interface with the system through an input interface 514. Output devices such as a monitor, speakers, etc are shown as 516. The output devices interface with the computer 500 through an output interface 518. External memory such as a hard drive is shown as 520. A library of circuits and routines used in the present invention are stored in the external memory 520, in the ROM 508 or in a combination of the two. It should be appreciated that there are other computer readable mediums such as compact disk and digital video disk. The computer readable-mediums such as hard drive 520 may store data or store computer instructions. The computer instructions stored on the computer readable medium may cause the computer to perform various methods presented in the present invention.

The method and apparatus of the present invention may be implemented in software such as simulation software. The electronic system is implemented using devices from a device library. The library includes the parameters that characterize the performance and operation of the devices. The devices are combined in a simulator to form circuits. The circuits of interest will be extracted and simulated using the device library. This will give an accurate circuit for use in the circuit simulator. Once the circuit of interest has been extracted in accordance with the method of the present invention, a simulation is performed.

The simulation uses data located in libraries, flat files or other formats. The data may be centrally located or distributed. In addition, the data may be stored in a static computer readable medium or in a removable computer readable medium. The data may be accessed by any access method such as across a network or across the back plane of a computing machine. The software instructions used to perform the method of the present invention may be centrally located or distributed and access libraries that are centrally located or distributed. Automation procedures are anticipated which download the instruction from a central repository, such as a server and run the instructions on an end-user machine. The software instructions may be stored in a computer readable medium such as a computer disk. In addition, the software may access the data and cause the computer system to run a simulation, which is then displayed as text data, two-dimensional or three dimensional static or moving images. End-users may ultimately interact with the data and control the simulation using the computer input devices such as keyboards and joysticks.

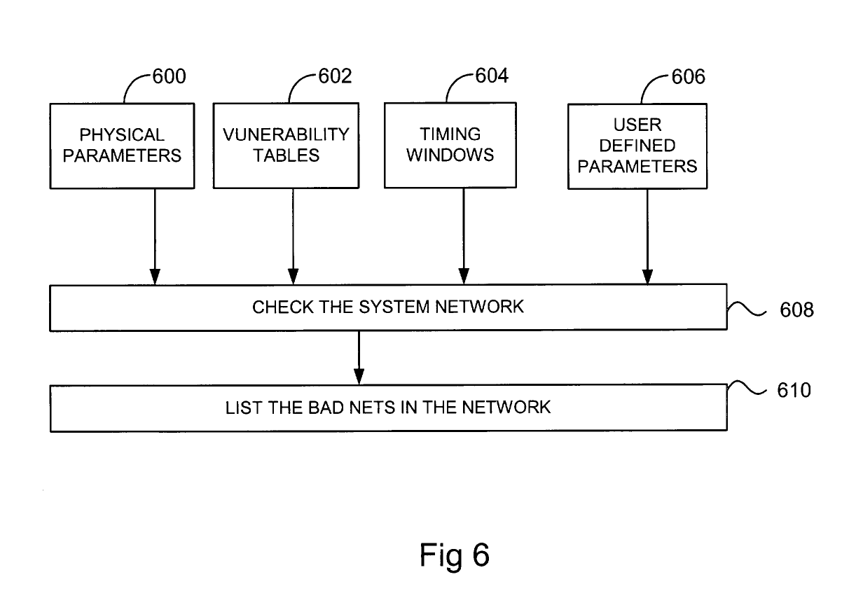

FIG. 6 displays a flow diagram implementing the method of the present invention. In the method of the present invention the physical parameters of the circuit are shown as 600. The physical parameters include all signal capacitance, all signal resistance, all line lengths, all gate placements, etc. Vulnerability tables 602 are produced as described above and timing windows 604 are produced as described above. Lastly, end-user defined noise limits are input into the system as shown by 606.

The nets (e.g. gates, wires and combinations of gates and wires or traces) are analyzed as shown at 608. In the checking the system network, every signal is analyzed to identify all possible aggressors. A vulnerability table look-up is then performed to determine if the signal exceeds the end-user defined threshold. Specifically, the electronic system is checked by identifying a signal for analysis; calculating the coupling efficiency for the signal; looking up the line lengths in a line lengths database; going to the vulnerability table and using the coupling efficiency and the line lengths to read the noise level from the vulnerability table and then determining whether noise read from the vulnerability table exceeds the threshold. If the noise does not exceed the vulnerability threshold the next signal is analyzed using the method presented. Once this is completed a list of the bad nets are presented to the end-user as shown by 610 or stored.

In the method and apparatus of the present invention, a number of efficiencies are implemented. Devices and circuits that have a similar configuration are not replicated, but instead are produced once and links are made in the simulation, so that by calculating the performance of one, the performance of all is calculated. Therefore, the coordination and interrelation of redundant circuit configurations is also within the teachings of the present invention.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of characterizing an electronic system comprising the steps of:
defining a range of drive strength;
defining a range of line lengths;
defining a range of coupling efficiency values; and
generating a vulnerability table in response to the range of drive strengths, in response to the range of line lengths and in response to the range of coupling efficiency values.

2. A method of characterizing an electronic system as set forth in claim 1, wherein the method is implemented with computer instructions stored on a computer readable medium which when accessed by a computer cause the computer to perform the method of claim 1.

3. A method of characterizing an electronic system as set forth in claim 1, wherein the method is implemented with computer instructions, the computer instructions are stored on a computer readable medium, the computer readable medium is distributed in at least two computers.

4. A method of characterizing an electronic system as set forth in claim 1, wherein the method is implemented by computer instructions, which access data stored on a computer readable medium.

5. An apparatus comprising:
a means for defining a range of drive strength;
a means for defining a range of line lengths;
a means for defining a range of coupling efficiency values; and
a means for generating a vulnerability table in response to the range of drive strengths, in response to the range of line lengths and in response to the range of coupling efficiency values.

6. A method of characterizing an electronic system comprising the steps of:
(a) defining a first drive strength;
(b) identifying a first signal path including first line length;
(c) identifying a second signal path including a second line length, wherein the second line length is equivalent to the first line;
(d) modeling coupling between the first signal path and the second signal path;
(e) establishing a coupling efficiency in response to modeling coupling between the first signal path and the second signal path;
(f) generating a noise value in response to the drive strength, in response to the first line length and in response to the coupling efficiency;
(g) generating a two-dimensional vulnerability relationship for the first line length by repeating steps (e) through (f);
(h) generating a two-dimensional vulnerability relationship for multiple line lengths by repeating steps (b) through (g) for a new line length wherein the new line length is always a different numerical value; and
(i) generating a three-dimensional vulnerability relationship by repeating steps (b) through (h) and defining a second drive strength wherein the second drive strength is different from the first drive strength.

7. A method of characterizing an electronic system comprising the steps of:
defining a plurality of devices in the electronic system; and
generating a plurality of vulnerability tables, with at least one of the vulnerability tables associated with at least one of the plurality of devices.

8. A method as set forth in claim 7, wherein the plurality of devices include logical gates.

9. A method as set forth in claim 7, wherein the plurality of devices include storage devices.

10. A method of characterizing an electronic system as set forth in claim 7, wherein the method is implemented with computer instructions stored on a computer readable medium which when accessed by a computer cause the computer to perform the method of claim 7.

11. An apparatus comprising:
means for defining a plurality of devices in the electronic system; and
means for generating a plurality of vulnerability tables, with at least one of the vulnerability tables associated with at least one of the plurality of devices.

12. A method of characterizing an electronic system comprising the steps of:
defining a vulnerability window for an input to a storage device;
determining a range of delay times for a signal communicated from a driving device to the input to the storage device; and
generating a mapped vulnerability window in response to the vulnerability window and in response to the range of delay times.

13. A method of characterizing an electronic system as set forth in claim 12, wherein the input to the storage device is a data input to the storage device.

14. A method of characterizing an electronic system as set forth in claim 12, wherein the input to the storage device is a clock input to the storage device.

15. A method of characterizing an electronic system as set forth in claim 12, wherein the input to the storage device is a synchronous control input to the storage device.

16. A method of characterizing an electronic system as set forth in claim 12, wherein the input to the storage device is an asynchronous control input to the storage device.

17. A method of characterizing an electronic system as set forth in claim 12, wherein the method is implemented with computer instructions stored on a computer readable medium which when accessed by a computer cause the computer to perform the method of claim 16.

18. An apparatus comprising:
means for defining a vulnerability window for an input to a storage device;
means for determining a range of delay times for a signal communicated from a driving device to the input to the storage device; and
means for generating a mapped vulnerability window in response to the vulnerability window and in response to the range of delay times.

19. A method of characterizing an electronic system, the method comprising the steps of:
identifying an input to a storage device; and
generating a vulnerability window for the input to the storage device.

20. A method of characterizing an electronic system as set forth in claim 19, wherein the input to the storage device is a data input.

21. A method of characterizing an electronic system as set forth in claim 19, wherein the input to the storage device is a synchronous control input.

22. A method of characterizing an electronic system as set forth in claim 19, where the input to the storage device is an asynchronous control input.

23. A method of characterizing an electronic system as set forth in claim 19, where the input to a storage device is a clock input.

24. A method of characterizing an electronic system as set forth in claim 19, wherein the method is implemented with computer instructions stored on a computer readable medium which when accessed by a computer cause the computer to perform the method of claim 19.

25. An apparatus comprising:
means for identifying an input to a storage device; and
means for generating a vulnerability window for the input to the storage device.

26. A method of determining signal integrity in an electronic system comprising the steps of:
simulating operation of the storage device including a node; and
characterizing the signal integrity of the electronic system by measuring the node of the storage device to determine a state of the storage device.

27. A method of determining signal integrity of an electronic system as set forth in claim 26 wherein node of the storage element is an internal node.

28. A method of determining signal integrity of an electronic system as set forth in claim 26 wherein node of the storage element is an external node.

29. A method of determining signal integrity of an electronic system as set forth in claim 26 wherein signal integrity is determined by measuring the node of the storage device to determine if the storage device has stored incorrect data.

30. A method of characterizing an electronic system as set forth in claim 26, wherein the method is implemented with computer instructions stored on a computer readable medium which when accessed by a computer cause the computer to perform the method of claim 26.

31. An apparatus comprising:
means for simulating operation of the storage device including a node; and
means for characterizing the signal integrity of the electronic system by measuring the node of the storage device to determine a state of the storage device.

32. A method of determining signal integrity in an electronic system comprising the steps of:
simulating operation of a gate driving a storage device, the storage device including a node; and
characterizing the signal integrity of the electronic system by measuring the node of the storage device to determine a state of the storage device.

33. A method of determining signal integrity of an electronic system as set forth in claim 32, wherein the node of the storage device is an internal node.

34. A method of determining signal integrity of an electronic system as set forth in claim 32, wherein the node of the storage device is an external node.

35. A method of determining signal integrity of an electronic system as set forth in claim 32, wherein signal integrity is determined by measuring the node of the storage device to determine if the storage device has an incorrect state.

36. A method of characterizing an electronic system as set forth in claim 32, wherein the method is implemented with computer instructions stored on a computer readable medium which when accessed by a computer cause the computer to perform the method of claim 32.

37. An apparatus comprising:
means for simulating operation of a gate driving a storage device, the storage device including a node; and
means for characterizing the signal integrity of the electronic system by measuring the node of the storage device to determine a state of the storage device.

38. A method of characterizing an electronic system, the electronic system including at least one trace providing a signal to a storage device, the method comprising the steps of:
defining a time period during which noise on the trace will cause the storage device to store incorrect data; and
defining device relationships in the electronic system in response to the time period.

39. A method of characterizing an electronic system as set forth in claim 38, wherein the signal is a data signal and the trace is a data input to the storage device.

40. A method of characterizing an electronic system as set forth in claim 38, wherein the signal is a clock signal and the trace is a clock input to the storage device.

41. A method of characterizing an electronic system as set forth in claim 38, wherein the signal is a synchronous control signal and the trace is a synchronous control input to the storage device.

42. A method of characterizing an electronic system as set forth in claim 38, wherein the signal is an asynchronous control signal and the trace is an asynchronous control input to the storage device.

43. A method of characterizing an electronic system as set forth in claim 38, wherein a data flow failure mechanism is simulated in response to the step of defining the device relationships.

44. A method of characterizing an electronic system as set forth in claim 38, wherein a clock failure mechanism is simulated in response to the step of defining the device relationships.

45. A method of characterizing an electronic system as set forth in claim 38, wherein simulation of a synchronous control failure mechanism is simulated in response to the step of defining the device relationships.

46. A method of characterizing an electronic system as set forth in claim 38, wherein simulation of an asynchronous control failure mechanism is simulated in response to the step of defining the device relationships.

47. A method of characterizing an electronic system as set forth in claim 38, wherein the method is implemented with computer instructions stored on a computer readable medium which when accessed by a computer cause the computer to perform the method of claim 38.

48. An apparatus comprising:
means for defining a time period during which noise on the trace will cause the storage device to store incorrect data; and
means for defining device relationships in the electronic system in response to the time period.

49. A method of determining signal integrity in an electronic system comprising the steps of:
defining a storage device including an input;
generating a vulnerability table associated with the input of the storage device;
generating a vulnerability window associated with the input to the storage device; and
defining invalid operation of the electronic system in response to the vulnerability table associated with the storage device and in response to the vulnerability window associated with the input to the storage device.

50. A method of determining signal integrity in an electronic system comprising the steps of:
defining a gate driving a storage device, the storage device including a vulnerability window associated therewith;
generating a vulnerability table associated with the gate;
generating a mapped vulnerability window associated with the gate, the mapped vulnerability window generated in response to the vulnerability window associated with the storage device; and
defining invalid operation of the electronic system in response the vulnerability table associated with the gate and in response to the mapped vulnerability window associated with the gate.
